(19) United States
(12) Patent Application Publication
(10) Pub. No.: US 2017/0125924 A1
(43) Pub. Date: May 4, 2017

(54) Generation of a Splice Between Superconductor Materials

(71) Applicant: Brookhaven Science Associates, LLC, Upton, NY (US)

(72) Inventor: Seetha Lakshmi Lalitha, East Lansing, MI (US)

(21) Appl. No.: 15/305,696

(22) PCT Filed: Apr. 21, 2015
(86) PCT No.: PCT/US2015/026815

§ 371 Date: Oct. 21, 2016

Related U.S. Application Data
(60) Provisional application No. 61/984,520, filed on Apr. 25, 2014.

(51) Int. Cl. H01R 4/68; H01B 1/08; C22C 28/00; B23K 1/00; B23K 35/26; B23K 3/04; H02G 1/00; H02G 1/14

(52) U.S. Cl. CPC H01R 4/68; H02G 1/005; H01B 1/08; H02G 1/14; B23K 1/0016; B23K 35/26; B23K 3/04; C22C 28/00

(57) ABSTRACT

Technologies are described for methods and systems to generate a splice between a first and a second piece of conductor material. The methods may comprise identifying a first overlap area for the first piece on a first conductive surface. The first piece may include the first conductive surface and a first non-conductive surface. The methods may comprise identifying a second overlap area for the second piece on a second conductive surface. The second piece may include the second conductive surface and a second non-conductive surface. The methods may comprise pre-tinning the first and second overlap areas with solder to produce first and second pre-tinned areas. The methods may comprise stacking the first and second pieces so that the first and second pre-tinned areas are in contact and applying heat to the first non-conductive surface sufficient to melt the solder and generate the splice between the first and second pieces.

The present application was made with government support under contract numbers DE-ACO2-98CH 10886 and DE-SC0012704 awarded by the U.S. Department of Energy. The United States government has certain rights in the invention(s).

### FIELD OF THE INVENTION

This application relates to the broad spectrum of potential technology based on the high temperature superconductor materials.

### BACKGROUND

Examples of superconductor materials include low temperature superconductors (LTS) and high temperature superconductors (HTS). LTS materials such as NbTi and Nb₃Sn may be cooled to about 4° K to become superconducting. HTS materials may become superconducting above 77° K. Early commercially available HTS materials were bismuth-based ceramic oxides featuring Bi-2212 and Bi-2223 and are sometimes referred to as first generation HTS. On the other hand, the second generation HTS materials have been developed using rare earth barium copper oxide ceramics. The rare earth element may be Yttrium, Samarium, and Gadolinium. These HTS materials are commercially available in the form of a thin flat tape and are also referred to as multi-layer coated conductors. HTS tape may be used in many applications and devices, for example, a superconducting magnetic energy storage (SMES) device which includes a superconducting magnet. This superconducting magnet may assume different geometries such as a solenoid or a toroid. A solenoid magnet may also be assembled from a series of pancake coils.

### SUMMARY

In some examples, methods for generating a splice between first and second pieces of conductor material are described. The methods may comprise identifying a first overlap area for the first piece. The first piece may include a first layer including a rare earth barium copper oxide. The first piece may include a first conductive surface that is part of a first conductive path to the rare earth barium copper oxide in the first piece. The first piece may include a first non-conductive surface opposite the first conductive surface. The first non-conductive surface may not provide the first conductive path to the rare earth barium copper oxide in the first piece. The first overlap area may be on the first conductive surface. The methods may comprise identifying a second overlap area for the second piece. The second piece may include a second layer including the rare earth barium copper oxide. The second piece may include a second conductive surface that is part of a second conductive path to the rare earth barium copper oxide in the second piece. The second piece may include a second non-conductive surface opposite the conductive surface. The second non-conductive surface may not provide the second conductive path to the rare earth barium copper oxide in the second piece. The second overlap area may be on the conductive surface. The methods may comprise pre-tinning the first and second overlap areas with solder to produce first and second pre-tinned areas. The methods may comprise stacking the first piece and the second piece so that the first pre-tinned area is in contact with the second pre-tinned area. The methods may comprise heating the first non-conductive surface. The heat may be sufficient to melt the solder and generate the splice between the first and second pieces. This may form a lap joint type splice where segments of the two pieces are joined.

In some examples, structures including a splice between a first and second piece of conductor material are described. The structures may comprise a first piece of conductor material. The first piece may include a first layer including a rare earth barium copper oxide. The first piece may include a first conductive surface that is part of a first conductive path to the rare earth barium copper oxide in the first piece. The first piece may include a first non-conductive surface opposite the first conductive surface. The first non-conductive surface may not provide the first conductive path to the rare earth barium copper oxide in the first piece. The first piece may include a first overlap area. The first overlap area may be part of the first conductive surface. The structures may comprise a second piece of conductor material. The second piece may include a second layer including the rare earth barium copper oxide. The second piece may include a second conductive surface that is part of a second conductive path to the rare earth barium copper oxide in the second piece. The second piece may include a second non-conductive surface opposite the second conductive surface. The second non-conductive surface may not provide the second conductive path to the rare earth barium copper oxide in the second piece. The second piece may include a second overlap area. The second overlap area may be part of the second conductive surface. The structures may comprise a layer of indium solder. The layer of indium solder may be effective to generate a splice between the first overlap area and the second overlap area.

In some examples, systems effective to generate a splice between a first and a second piece of conductor material are described. The systems may comprise a top block including a base portion and an extension portion. The systems may comprise a bottom block configured to interlock with the top block. The bottom block may include walls that, with the extension portion, define a mounting space. The systems may comprise a first piece of conductor material in the mounting space. The first piece may include a first layer including a rare earth barium copper oxide. The first piece may include a first conductive surface that is part of a first conductive path to the rare earth barium copper oxide in the first piece. The first piece may include a first non-conductive surface opposite the first conductive surface. The first non-conductive surface may not provide the first conductive path to the rare earth barium copper oxide in the first piece. The first piece may include a first pre-tinned overlap area pre-tinned with solder. The first pre-tinned overlap area may be part of the first conductive surface. The system may comprise a second piece of conductor material in the mounting space. The second piece may include a second layer including the rare earth barium copper oxide. The second piece may include a second conductive surface that is part of a second conductive path to the rare earth barium copper oxide in the second piece. The second piece may include a second non-conductive surface opposite the second conductive surface. The second non-conductive surface may not provide the second conductive path to the rare earth barium copper oxide in the second piece. The second piece may include a second pre-tinned overlap area pre-tinned with the solder. The second pre-tinned overlap area may be part of the second conductive surface and overlap the first pre-tinned overlap area. The systems may comprise cartridge heaters effective to provide heat to the top and bottom block. The heat may be sufficient to melt the solder and generate the splice between the first and second pieces.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1A, 1B, 1C and 1D illustrate an example of a system that can be utilized to generate a splice between superconductor materials;

FIGS. 2A and 2B illustrate the example system of FIG. 1 effective to generate a splice between superconductor materials with additional details about soldering;

FIG. 3 illustrates a side cross-section view of a splice generated between superconductor materials with a representation of current distribution in a high temperature superconductor (HTS) layer and through the splice;

FIG. 4 illustrates a top view of pieces of first and second superconductor materials with a splice bent around a mandrel;

FIG. 5 is a top view of a first and second piece of superconductor materials connected with a splice from a third piece of superconductor material;

FIG. 6A illustrates a side cross-section view of a splice generated between superconductor materials which include additional backing from copper on both sides of the superconductor materials;

FIG. 6B illustrates a side cross-section view of a splice generated between superconductor materials which include additional backing from copper on one side of the superconductor materials;

FIGS. 7A and 7B illustrate an example of a side cross-sectional view of an apparatus that can be utilized to generate a splice between superconductor materials; and

FIG. 8 illustrates a flow diagram of an example process utilized to generate a splice between superconductor materials; all arranged according to at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof.

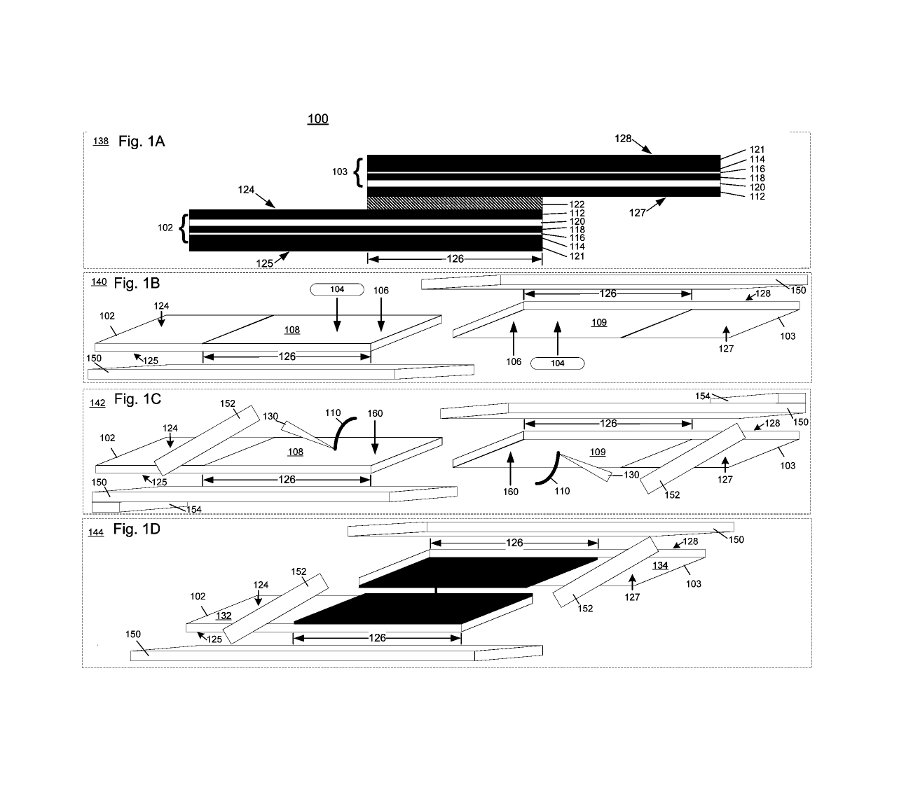

FIG. 1 illustrates an example system 100 that can be utilized to generate a splice between superconductor materials, arranged in accordance with at least some embodiments presented herein. As discussed in more detail below, splices between high temperature conductor materials such as superconductor (HTS) tape may be generated. These may be a lap joint type splice where segments of the two materials are joined. The splices may exhibit resistance across the splice below 5 nΩ.

In an example, system 100 may include a first piece of HTS tape 102 and a second piece of HTS tape 103 between which a splice may be generated. Pieces of HTS tape 102, 103 may be thin flat tape, with a thickness significantly less than a width. Each piece of HTS tape 102, 103 may be a multi-layer coated conductor including at least one layer of rare earth barium copper oxide ((RE)BCO).

As shown at 138 of FIG. 1A, each piece of HTS tape 102, 103 may include first copper stabilization layer 112, substrate layer 114, buffer layer 116, high temperature superconductor (HTS) rare earth barium copper oxide, ((RE)BCO) layer 118, a silver over layer 120, and a second copper stabilizing layer 121. The individual layers 121, 114, 116, 118, 120, 112 within each piece of HTS tape 102 and 103 may influence physical properties such as a conductive path of electricity within each piece of HTS tape 102 and 103. Each piece of HTS tape 102 and 103 may be part of a longitudinal conductive path through HTS rare earth barium copper oxide ((RE)BCO) layer 118. Piece of HTS tape 102 may include two surfaces, tape surface 124, facing towards the HTS rare earth barium copper oxide ((RE)BCO) layer 118, that is part of a transverse conductive path and the opposite tape surface 125, facing towards the substrate layer 114, that is not part of a transverse conductive path. Similarly, piece of HTS tape 103 may include a tape surface 127, facing towards the HTS rare earth barium copper oxide ((RE)BCO) layer 118, that is part of a transverse conductive path and the opposite tape surface 128, facing towards substrate layer 114, that is not part of a transverse conductive path. The transverse conductive path may be defined based on the orientation of the HTS rare earth barium copper oxide ((RE)BCO) layer 118 over the substrate layer 114 and oriented towards the respective tape surfaces (124, 127) of each piece of the HTS tape 102 and 103. Tape surfaces 125 and 128 of pieces of HTS tape 102 and 103 respectively may include substrate layer 114 and buffer layer 116 in a conductive path to HTS rare earth barium copper oxide ((RE)BCO) layer 118 and may have a relatively high electrical resistance compared to a transverse conductive path to HTS ((RE(BCO)) layer 118 for tape surfaces 124 and 127. Tape surfaces 125 and 128 may be considered to not have a conductive path to HTS ((RE(BCO)) layer 118 as a result of the relatively high resistance.

In some examples, pieces of HTS tape 102 and 103 may include HTS rare earth barium copper oxide ((RE)BCO) layer 118 on both sides of substrate layer 114. In such examples, tape surfaces 124 and 125 may be symmetric and have substantially identical electric resistance where each surface is part of a transverse conductive path to the HTS layer 118, and the HTS layer is closest to each respective surface in piece of HTS tape 102. Likewise, tape surfaces 127 and 128 may be symmetric and have substantially identical electric resistance where each surface is part of a transverse conductive path to the HTS layer 118 closest to each respective surface in piece of HTS tape 103. In other examples, pieces of HTS tape 102, 103 may include first and second copper stabilizer layers 112, 121, or may include only first copper stabilizer layer 112 or second copper stabilizer 121. In some examples, copper stabilizer layers 112 and 121 may fully surround pieces of HTS tape 102 and 103.

Piece of HTS tape 102 may not be long enough for an application. As discussed in more detail throughout, a splice may be generated between pieces of HTS tape 102 and 103 to generate a HTS tape long enough for the application. First, each piece of HTS tape 102, 103 may be cleaned. For clarity, illustrations at 140, 142 and 144 will not depict layers 121, 114, 116, 118, 120, 112 and will indicate tape surface 124 and tape surface 125 for piece of HTS tape 102 and tape surface 127 and tape surface 128 for piece of HTS tape 103.

As shown at 140 of FIG. 1B, cleaning may be performed at identified overlap area 108 on surface 124 of HTS tape 102 and overlap area 109 of surface 127 of HTS tape 103. Overlap areas 108 and 109 may be the areas identified where piece of HTS tape 102 overlaps piece of HTS tape 103 when generating a splice. The length of overlap areas 108 and 109 may be the length of splice 126 and may be determined based on conductive properties of pieces of HTS tapes 102 and 103. The width of overlap areas 108 and 109 may be the width of pieces of HTS tape 102 and 103, in some examples 12 mm, and the length of overlap areas 108 and 109, or length of the splice 126, may be 5-75 cm. Pieces of HTS tape 102, 103 may be on flat surface 150. Flat surface 150 may be a sufficiently long heat resistant block comprised of G-10 material or MICARTA. As shown at 140, cleaning may be performed with a non-scratch scrubbing cloth 104 and volatile organic liquid 106. A user may use non-scratch scrubbing cloth 104 to gently rub overlap areas 108 and 109 to clean without abrasion of the surface of pieces of HTS tape 102 and 103. A lint free tissue wipe may be soaked with volatile organic liquid 106 and may be used to wet overlap areas 108 and 109 sufficiently to clean. Volatile organic liquid 106 may evaporate after cleaning overlap area 108, 109. Volatile organic liquid 106 may be for example, acetone or ethyl alcohol.

Once cleaned and dry, each piece of HTS tape 102, 103 may be pre-tinned, as shown at 142 of FIG. 1C. Each piece of HTS tape 102, 103 may be kept straight on flat surface 150. Pieces of HTS tape 102, 103 may be secured to flat surface 150 using tape 152 or a KAPTON. An example tape 152 may be masking tape. One end of each piece of HTS tape 102 and 103 may be kept at higher elevation compared to the other end of the HTS tape 102 and 103, such as to form an angle of 30-60 degrees between flat surface 150 and a level surface beneath flat surface 150. A block 154 may be placed under flat surface 150 to elevate one end and form the angle. Pre-tinning may be performed by applying a thin layer of soldering flux 160 and then solder 110. Soldering flux 160 may be non-lead based and electronic grade. Solder 110 may be an indium based solder such as 98% indium and 2% silver solder. Solder 110 may be lead free. Solder 110 may be a thin wire of indium solder and may be applied to overlap areas 108 and 109 with a solder iron 130. Solder iron 130 may heat solder 110 sufficient to melt solder onto overlap area 108, 109. Soldering flux 160 and solder 110 may be applied from an elevated end of overlap area 108, 109 to a lower end of overlap area 108, 109.

As shown at 144 of FIG. 1D, solder 110 melted on overlap area 108 may form pre-tinned layer 111, which may be a thin uniform layer of solder.

Similarly solder 110 melted on overlap area 109 may form pre-tinned layer 113. An amount of solder 110 applied to overlap areas 108 and 109 may be a minimum amount necessary to coat or wet overlap area 108 and 109 with solder 110. Pre-tinning may also be performed using an indium ribbon to form pre-tinned layers 111 and 113. Excess solder 110 may appear as a blob at one end of pieces of HTS tape 102, 103. Excess solder 110 may be removed using solder iron 130 or by cutting a section of the piece of HTS tape 102, 103 where the excess solder 110 is located. The size of the cut in piece of HTS tape 102, 103 may be roughly the size of the blob, for example about 2-3 mm².

When pre-tinning of both pieces of HTS tape 102 and 103 is complete, pieces of HTS tape 102 and 103 may be stacked and aligned. Pieces of HTS tape 102 and 103 may be aligned such that pre-tinned layers 111 and 113 overlap and face each other and non-tinned portions 132 and 134 do not overlap each other. In an example, piece of HTS tape 102 and piece of HTS tape 103 may extend from overlapped pre-tinned layers 111 and 113 in opposing directions.

Pieces of HTS tape 102 and 103 may be stacked and secured on flat surface 150. Securing pieces of HTS tape 102 and 103 to surface 150 may be performed with tape 152 so as to prevent movement of pieces 102 and 103 and to not damage pieces of HTS tape 102 and 103. As discussed in more detail below, pieces of HTS tape 102 and 103 may be soldered together to generate splice solder layer 122 connecting the two pieces together.

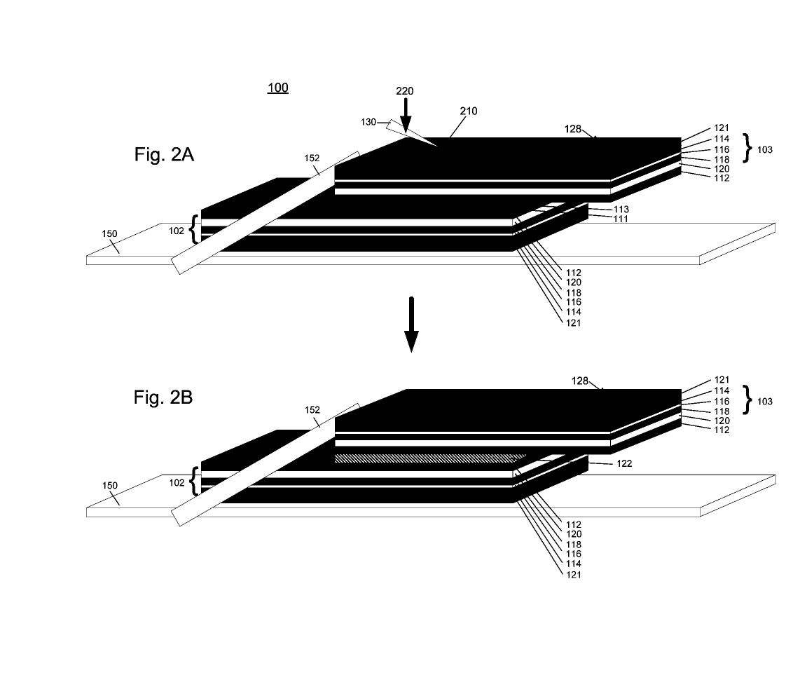

FIG. 2 illustrates the example system of FIG. 1 effective to generate a splice between superconductor materials with additional details about soldering, arranged in accordance with at least some embodiments presented herein. Those components in FIG. 2 that are labeled identically to components of FIG. 1 will not be described again for the purposes of clarity.

In FIGS. 2A and 2B, pieces of HTS tape 102 and 103 having been aligned and secured to flat surface 150 may be soldered together to generate splice solder layer 122. Soldering iron 130 may apply heat 210 to surface 128 of piece of HTS tape 103 so as to heat pre-tinned layers 113 and 111 shown in FIG. 2A. Piece of HTS tape 103 may conduct heat 210 from solder iron 130 to pre-tinned layers 113 and 111. Solder iron 130 may apply sufficient heat 210 to melt solder in pre-tinned layers 113 and 111 and generate splice solder layer 122 shown in FIG. 2B. Solder iron 130 may be set to a temperature from 190° C. to 230° C., from 190° C. to 225° C. or from 190° C. to 220° C. In an example, solder iron may be set to 215° C. Solder iron 130 may include about 2.5 mm wide soldering chisel tip. The chisel tip of solder iron 130 and additionally a small block of G-10 material may also apply pressure 220 to tape surface 128 of piece of HTS tape 103 as heat 210 is applied so as to prevent and remove voids between pre-tinned layers 113 and 111. Heat 210 and pressure 220 may be applied by soldering iron 130 to piece of HTS conductor material 103 for between about 5 seconds and about 20 seconds.

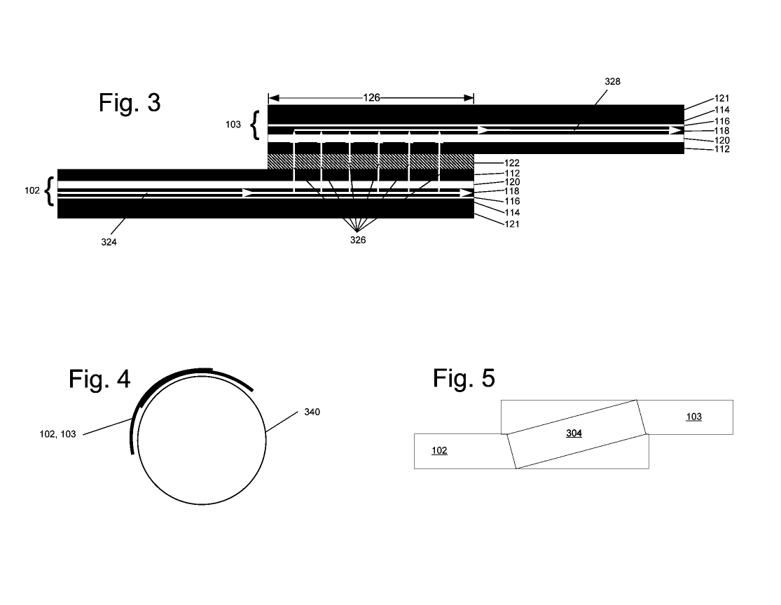

FIG. 3 illustrates a side cross-section view of a splice generated between superconductor materials with a representation of current distribution in a high temperature superconductor (HTS) layer and through the splice, arranged in accordance with at least some embodiments presented herein. Those components in FIG. 3 that are labeled identically to components of FIG. 1-2 will not be described again for the purposes of clarity.

Pieces of HTS tape 102 and 103 may be connected together by splice solder layer 122. Electric current 324 may start and move through piece of HTS tape 102 within high temperature superconductor (HTS) rare earth barium copper oxide (RE)BCO layer 118 of HTS conductor material 102. Electric current 324 may travel through silver over-layer 120 and first copper stabilizer layer 112 of HTS tape 102, through splice solder layer 122, and through first copper stabilizer layer 112 and silver over-layer 120 of piece of HTS tape 103 as electric current 326. Electric current 328 may then move through piece of HTS conductor material 103 within high temperature superconductor (HTS) rare earth barium copper oxide (RE)BCO layer 118. An electric resistance across splice 122 between pieces of HTS conductor materials 102 and 103 may be determined by:

R=2(R_{Cu}+R_{Ag}+R_{ci}+R_{co})+R_{S}

where:

R_{Cu} is the resistance of first copper stabilizer layers 112;

R_{Ag} is the resistance of silver overlayer 120;

R_{ci} is the contact resistance between the HTS rare earth barium copper oxide (RE)BCO layer 118 and the silver overlayer 120 and between the silver overlayer 120 and the first copper stabilizer layer 112;

R_{co} is the contact resistance between first copper stabilizer layer 112 and the splice solder layer 122; and

R_{S} is the resistance of the indium based solder layer 122.

R_{Cu}, R_{Ag}, and R_{ci} may be constant parameters for HTS tape 102, 103. The electric resistance of across splice HTS tape pieces may be dependent on R_{co} and R_{S} and may be controlled by thickness of splice solder layer 122 and solder quality.

Pieces of HTS tape 102 and 103 soldered together with indium based solder may exhibit a splice resistance below 5 nΩ. Pieces of HTS tape 102 and 103 soldered together with indium base solder may exhibit splice resistance less than 1 nΩ at 77° K for a splice length of 75 cm. Pieces of HTS tape 102 and 103 soldered together with indium base solder may exhibit splice resistance of 22.4 nΩ-cm².

FIG. 4 illustrates a top view of pieces of first and second superconductor materials pieces 102 and 103 with a splice 122 bent around a mandrel 340, arranged in accordance with at least some embodiments presented herein. Those components in FIG. 4 that are labeled identically to components of FIG. 1-3 will not be described again for the purposes of clarity.

Pieces of HTS tape 102 and 103 soldered together with indium base solder may exhibit consistent splice resistance even when mechanically deformed, such as bending around an 11.4 cm mandrel. Pieces of HTS tape 102 and 103 soldered together with indium based solder may exhibit mechanical stability. For example, pieces of HTS tape 102 and 103 soldered together with indium based solder may be bent in an individual turn of a pancake coil. The length of the splice may be 15 cm. A mandrel 340 for a pancake coil may be 11.4 cm in diameter. The pieces of HTS tape 102 and 103 soldered together with indium based solder may remain mechanically stable when wound on the 11.4 cm mandrel. The pieces of HTS tape 102 and 103 soldered together with indium based solder may remain mechanically stable at a temperature of between about 400° K and 4° K or even lower temperature when wound on the 11.4 cm mandrel.

FIG. 5 is a top view of first and second pieces of HTS tape 102 and 103 connected with a splice from a third piece of superconductor material 304, arranged in accordance with at least some embodiments presented herein. Those components in FIG. 5 that are labeled identically to components of FIG. 1-4 will not be described again for the purposes of clarity.

A splice may be generated between two pieces of HTS tape 102 and 103 with use of a third piece of HTS tape 304. Pieces of HTS tape 102 and 103 may be adjacent and arranged with the same orientation of respective tape surfaces. FIG. 5 illustrates a top view of two adjacent pieces of HTS tape 102 and 103 with a splice generated with a third piece of HTS conductor material 304 spirally connecting pieces of HTS tape 102 with HTS tape 103. The conducting surface of third piece of HTS conductor material 304 may be cleaned and pre-tinned as previously detailed. Areas on the tape surface of pieces of HTS conductor materials 102 and 103 that third piece of HTS conductor material 304 may overlap may be cleaned and pre-tinned. Third piece of HTS conductor material 304 may be arranged such that pre-tinned tape surface offering lowest transverse resistance is in contact with pre-tinned areas of pieces of HTS tape material 102 and 103. Third piece of HTS conductor tape 304 may be arranged on a spiral overlapping and connecting adjacent pieces of HTS tape 102 and 103. Heat may be applied to the non-conducting surface of third piece of HTS tape 304 as previously detailed to generate a spiral splice between pieces of HTS tape 102 and 103.

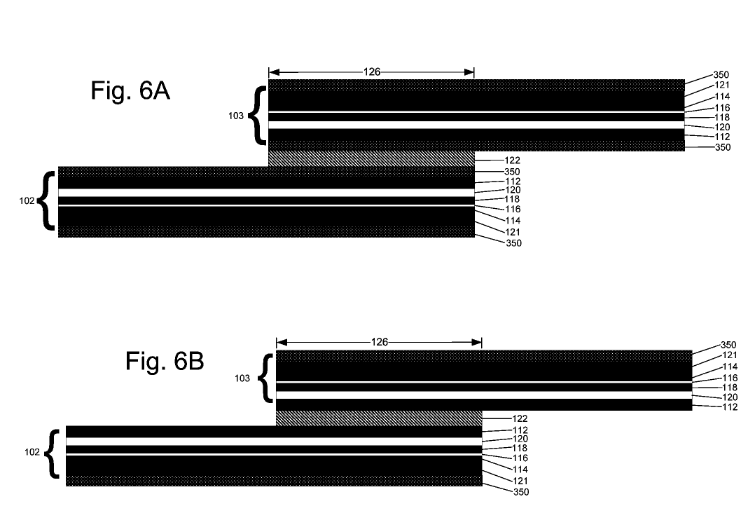

FIG. 6A illustrates a side cross-section view of a splice generated between superconductor materials which include additional backing from copper on both sides, arranged in accordance with at least some embodiments presented herein. FIG. 6B illustrates a side cross-section view of a splice generated between superconductor materials which include additional backing from copper on one side, arranged in accordance with at least some embodiments presented herein. Those components in FIG. 6A and FIG. 6B that are labeled identically to components of FIG. 1-5 will not be described again for the purposes of clarity.

Pieces of HTS tape 102 and 103 may include additional backing Additional backing for pieces of HTS tape 102 and 103 may be layers of copper 350 on one or both sides of pieces of HTS tape 102 and 103. FIG. 6A illustrates a splice generated between pieces of HTS tape 102 and 103 where pieces of HTS tape 102 and 103 include additional backing of layers of copper 350 on both sides. FIG. 6B illustrates a splice generated between pieces of HTS tape 102 and 103 where pieces of HTS tape 102 and 103 include additional backing layer of copper 350 on one side. Layers of copper 350 may provide pieces of HTS tape 102 and 103 with additional mechanical, electrical and thermal stability.

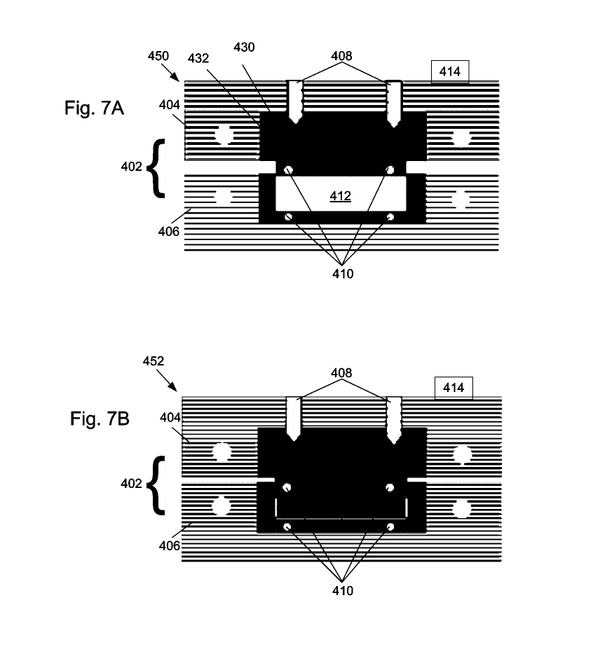

FIG. 7 illustrates an example of a side cross-sectional view of an apparatus that can be utilized to generate a splice between superconductor materials, arranged in accordance with at least some embodiments presented herein. Those components in FIG. 7 that are labeled identically to components of FIG. 1-6 will not be described again for the purposes of clarity.

As shown at 450 of FIG. 7A, an apparatus 402 may be utilized to generate a splice for HTS tapes. Apparatus 402 may include a top block 404 and a bottom block 406. Top block 404 may include springs 408, a conductive base portion 430 and an extension portion 432. Springs 408 may adjust contact pressure during generation of a splice. Springs 408 may apply pressure from extension portion 432 to the HTS tape during the generation of a splice between the HTS tapes. Bottom block 406 may include walls that, along with extension portion 432, may define a sample mounting space 412. Sample mounting space 412 may be used to receive pieces of HTS tape for which a splice is to be generated. Extension portion 432 and bottom block 406 may include cartridge heaters 410. Cartridge heaters 410 may be attached to a thermocouple 414. Thermocouple 414 may be used to monitor the temperature within sample mounting space 412 when top block 404 and bottom block 406 are interlocked. Top block 404 and bottom block 406 may be interlocked to facilitate generation of a splice. Cartridge heaters 410, may uniformly heat extension portion 432 and bottom block 406 to a temperature from room temperature to 275° C. Top block 404 and bottom block 406 may be made with stainless steel with a copper lining, copper, a copper alloy, or any combination thereof. Top block 404 and bottom block 406 may include an additional lining. The lining may consist of an insulating material added to the outer surface of top block 404 and bottom block 406 and may function as a safety feature. In an example, the length of top block 404 and bottom block 406 may be, for example, up to 80 cm.

As shown at 452 of FIG. 7B, apparatus 402 may receive pre-tinned HTS tape 420 and 422. Indium ribbon may also be used to pre-tin areas of HTS tape 420 and 422. HTS tape 420 and 422 may be arranged in sample mounting space 412 such that pre-tinned areas of HTS tape face each other and overlap. In an example, HTS tape 420 and 422 may extend from overlapped pre-tinned areas in opposing directions. After HTS tape 420 and 422 are received in sample mounting space 412, top block 404 may be interlocked into bottom mounting block 406. Apparatus 402 may apply pressure through springs 408 and heat through cartridge heater 410 to pre-tinned HTS conductor materials 420 and 422 to melt the solder and generate a splice between HTS tape 420 and 422.

Among other possible benefits, a system in accordance with the present disclosure may enable the generation of a splice between two pieces of HTS tape with a resistance of between about 1 nΩ and about 10 nΩ at a HTS operating temperature of 77° K. The generated splices may be mechanically and electrically robust at temperatures in the range of 77° K-4° K for both HTS and LTS devices. Extended lengths of HTS material, such as lengths that are kilometers long, may be generated.

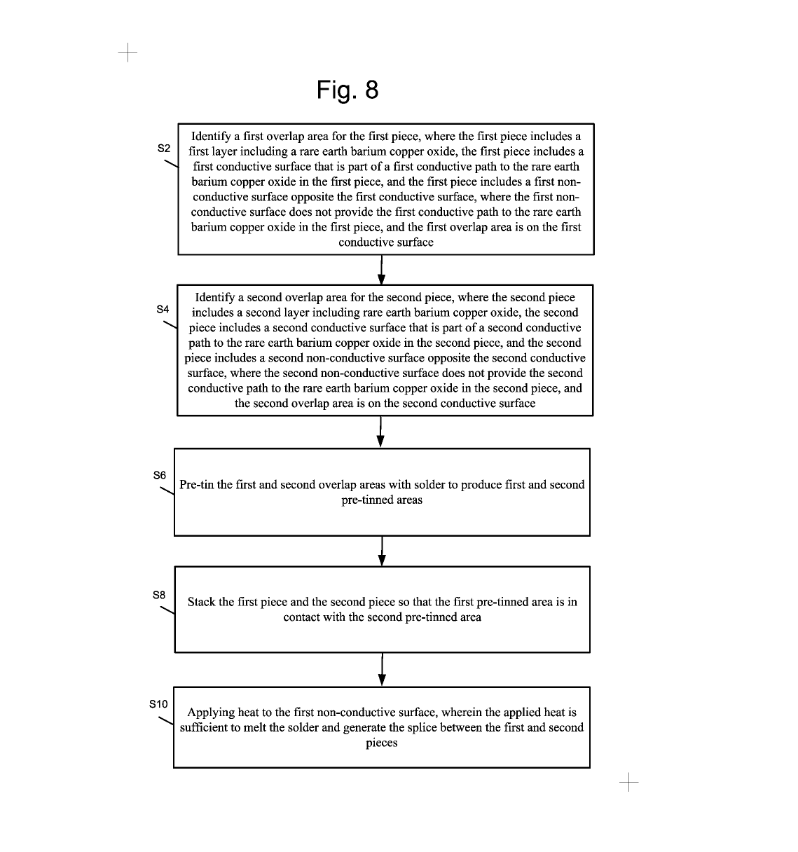

The process in FIG. 8 could be implemented using, for example, system 100 discussed above and may be used to generate a splice between superconductor materials. An example process may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

Processing may begin at block S2, “Identify a first overlap area for the first piece, where the first piece includes a first layer including a rare earth barium copper oxide, the first piece includes a first conductive surface that is part of a first conductive path to the rare earth barium copper oxide in the first piece, and the first piece includes a first non-conductive surface opposite the first conductive surface, where the first non-conductive surface does not provide the first conductive path to the rare earth barium copper oxide in the first piece, and the first overlap area is on the first conductive surface.” At block S2, a first overlap area may be identified for a first piece of HTS conductor material. The first piece of HTS conductor material may include a copper stabilized rare earth barium copper oxide (RE)BCO element. The first piece of HTS conductor material may include a copper stabilization layer, a substrate layer, a buffer layer, a high temperature superconductor (HTS) rare earth barium copper oxide (RE)BCO layer, a silver over layer, and a second copper stabilizer layer.

The first piece of HTS conductor material may include a first conductive surface. The first conductive surface may be part of a first conductive path to the rare earth barium copper oxide in the first piece of HTS conductor material. The first piece of HTS conductor material may also include a first non-conductive surface opposite the first conductive surface. The first non-conductive surface may not provide the first conductive path to the rare earth barium copper oxide in the first piece. The first overlap area may be on the first conductive surface.

Processing may continue from block S2 to block S4, “Identify a second overlap area for the second piece, where the second piece includes a second layer including rare earth barium copper oxide, the second piece includes a second conductive surface that is part of a second conductive path to the rare earth barium copper oxide in the second piece, and the second piece includes a second non-conductive surface opposite the second conductive surface, where the second non-conductive surface does not provide the second conductive path to the rare earth barium copper oxide in the second piece, and the second overlap area is on the second conductive surface.” At block S4, a second overlap area may be identified for a second piece of HTS conductor material. The second piece of HTS conductor material may include a copper stabilized rare earth barium copper oxide (RE)BCO element. The second piece of HTS conductor material may include a copper stabilization layer, a substrate layer, a buffer layer, a high temperature superconductor (HTS) rare earth barium copper oxide (RE)BCO layer, a silver over layer, and a second copper stabilizing layer.

The second piece of HTS conductor material may include a second conductive surface. The second conductive surface may be part of a second conductive path to the rare earth barium copper oxide in the second piece of HTS conductor material. The second piece of HTS conductor material may also include a second non-conductive surface opposite the second conductive surface. The second non-conductive surface may not provide the second conductive path to the rare earth barium copper oxide in the first piece. The second overlap area may be on the second conductive surface.

Processing may continue from block S4 to block S6, “Pre-tin the first and second overlap areas with solder to produce first and second pre-tinned areas.” At block S6, the first and second overlapped areas may be pre-tinned to produce first and second pre-tinned areas. Pre-tinning may be performed using solder. Solder may be an indium based solder such as 98% indium and 2% silver. Solder flux may be lead free and may be applied prior to soldering. Solder may be a thin wire of indium solder and may be applied to first and second overlap areas with a solder iron. The soldering iron may heat the solder with heat sufficient to melt the solder onto the first and the second overlap areas. Solder melted on the first and second overlap areas may form first and second pre-tinned areas. First and second pre-tinned areas may be thin uniform layers of solder. An amount of the solder applied to the first and second overlap areas may be a minimum amount necessary to coat or wet the first and second overlap areas with solder. Pre-tinning may also be performed using an indium ribbon to form first and second pre-tinned areas.

Processing may continue from block S6 to block S8, “Stack the first piece and the second piece so that the first pre-tinned area is in contact with the second pre-tinned area.” At block S8, the first piece and the second piece may be stacked so that the first pre-tinned area is in contact with the second pre-tinned area. The first piece and the second piece may extend from overlapped first and second pre-tinned areas in opposite directions.

The first and second pieces may be stacked and secured on a flat surface. The first and second pieces may be secured to the flat surface with tape so as to prevent movement of the first and second pieces and to not damage the first and second pieces. Masking tape may be used to secure the first and second pieces to the flat surface.

Processing may continue from block S8 to block S10, “Applying heat to the first non-conductive surface, wherein the applied heat is sufficient to melt the solder and generate the splice between the first and second pieces.” At block S10, heat may be applied with the soldering iron to the first non-conductive surface to melt the solder in the first and second pre-tinned areas and generate the splice between the first and second pieces. The solder iron may apply sufficient heat to melt the solder in the first and second pre-tinned areas and generate the splice. The solder iron may be set to a temperature from 190° C. to 230° C., from 190° C. to 225° C. or from 190° C. to 220° C. The solder iron may be set to 215° C. The solder iron may include a 2.5 mm wide soldering tip. The tip of the solder iron along with a block of G10 may also apply pressure to the first non-conductive surface as heat is applied so as to prevent and remove voids between the first and second pre-tinned areas.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for generating a splice between a first and a second piece of conductor material, the method comprising:
identifying a first overlap area for the first piece, where the first piece includes a first layer including a rare earth barium copper oxide, the first piece includes a first conductive surface that is part of a first conductive path to the rare earth barium copper oxide in the first piece, and the first piece includes a first non-conductive surface opposite the first conductive surface, where the first non-conductive surface does not provide the first conductive path to the rare earth barium copper oxide in the first piece, and the first overlap area is on the first conductive surface;
identifying a second overlap area for the second piece, where the second piece includes a second layer including the rare earth barium copper oxide, the second piece includes a second conductive surface that is part of a second conductive path to the rare earth barium copper oxide in the second piece, and the second piece includes a second non-conductive surface opposite the second conductive surface, where the second non-conductive surface does not provide the second conductive path to the rare earth barium copper oxide in the second piece, and the second overlap area is on the second conductive surface;
pre-tinning the first and second overlap areas with solder to produce first and second pre-tinned areas;
stacking the first piece and the second piece so that the first pre-tinned area is in contact with the second pre-tinned area; and
heating the first non-conductive surface, wherein the heat is sufficient to melt the solder and generate the splice between the first and second pieces.

2. The method of claim 1, further comprising prior to pre-tinning:
rubbing the first and second overlap areas of the first and second pieces with a scrubbing cloth to clean the first and second overlap areas.

3. The method of claim 1, further comprising wetting the first and second overlap areas of the first and second pieces with a volatile organic liquid to clean the first and second overlap areas.

4. The method of claim 3, wherein the volatile organic liquid is acetone, or ethyl alcohol.

5. The method of claim 1, wherein the solder is indium based and lead free.

6. The method of claim 1, wherein the solder is comprised of 98% indium and 2% silver.

7. The method of claim 1, wherein the solder is in the form of an indium ribbon.

8. The method of claim 1, wherein pre-tinning the first and second overlap areas includes:
applying a layer of soldering flux to the first and second overlap areas;
melting the solder with a soldering iron; and
applying a layer of melted solder to the first and second overlap areas.

9. The method of claim 1, wherein the heating is performed by applying heat to the first non-conductive surface with a soldering iron at a temperature of between about 190° C. and about 230° C.

10. The method of claim 9, wherein the soldering iron is at a temperature of 215° C. and the soldering iron includes a 2.5 mm wide soldering tip.

11. The method of claim 1, further comprising securing the first and second pieces to a surface with tape prior to pre-tinning so that a first end of the first piece is higher than a second end of the first piece, and a first end of the second piece is higher than a second end of the second piece.

12. The method of claim 1, wherein the length of the splice is between about 5 cm and about 75 cm.

13. The method of claim 1, wherein stacking the first piece and the second piece includes placing the first piece on the second piece so that the first and second pieces extend away from the overlapped first and second pre-tinned areas in opposing directions.

14. The method of claim 1, wherein the resistance across the splice is between about 1 nΩ and about 10 nΩ.

15. A structure comprising:
a first piece of conductor material, where the first piece includes a first layer including a rare earth barium copper oxide, the first piece includes a first conductive surface that is part of a first conductive path to the rare earth barium copper oxide in the first piece, and the first piece includes a first non-conductive surface opposite the first conductive surface, where the first non-conductive surface does not provide the first conductive path to the rare earth barium copper oxide in the first piece, and the first piece includes a first overlap area, the first overlap area being part of the first conductive surface;
a second piece of conductor material, where the second piece includes a second layer including the rare earth barium copper oxide, the second piece includes a second conductive surface that is part of a second conductive path to the rare earth barium copper oxide in the second piece, and the second piece includes a second non-conductive surface opposite the second conductive surface, where the second non-conductive surface does not provide the second conductive path to the rare earth barium copper oxide in the second piece, and the second piece includes a second overlap area, the second overlap area being part of the second conductive surface; and a layer of indium solder, the layer of indium solder effective to generate a splice between the first overlap area and the second overlap area.

16. The structure of claim 15, wherein the indium based solder is comprised of 98% indium and 2% silver.

17. The structure of claim 15, wherein the resistance across the splice is between about 1 nΩand about 10 nΩ.

18. The structure of claim 15, wherein the first piece and the second piece extend away from the first and second overlap areas in opposing directions.

19. A system effective to generate a splice between a first and a second piece of conductor material, the system comprising:
a top block including a base portion and an extension portion;
a bottom block configured to interlock with the top block, the bottom block including walls that, with the extension portion, define a mounting space;
a first piece of conductor material in the mounting space, where the first piece includes a first layer including the rare earth barium copper oxide, the first piece includes a first conductive surface that is part of a first conductive path to the rare earth barium copper oxide in the first piece, and the first piece includes a first non-conductive surface opposite the first conductive surface, where the first non-conductive surface does not provide the first conductive path to the rare earth barium copper oxide in the first piece, and the first piece includes a first pre-tinned overlap area pre-tinned with the solder, the first pre-tinned overlap area being part of the first conductive surface;
a second piece of conductor material in the mounting space, where the second piece includes a second layer including rare earth barium copper oxide, the second piece includes a second conductive surface that is part of a second conductive path to the rare earth barium copper oxide in the second piece, and the second piece includes a second non-conductive surface opposite the second conductive surface, where the second non-conductive surface does not provide the second conductive path to the rare earth barium copper oxide in the second piece, and the second piece includes a second pre-tinned overlap area pre-tinned with solder, the second pre-tinned overlap area being part of the second conductive surface and overlapping the first pre-tinned overlap area; and
a cartridge heater effective to provide heat to the top and bottom block, wherein the heat is sufficient to melt the solder and generate the splice between the first and second pieces.

20. The system of claim 19, further comprising at least one spring in the top or bottom block, the spring effective to apply pressure through the extension portion to the first and second pieces in the mounting space.
